(19) United States
(12) Patent Application Publication
(10) Pub. No.: US 2018/0281930 A1
(43) Pub. Date: Oct. 4, 2018

(54) Spanwise Traveling Electro Pneumatic Actuator Systems and Control Logic for Flow Control Applications

(71) Applicant: U.S.A. AS REPRESENTED BY THE ADMINISTRATOR OF NASA, WASHINGTON, DC (US)

(72) Inventors: Mehti Koklu, HAMPTON, VA (US); Latunia P. Melton, YORKTOWN, VA (US); John C. Lin, SEAFORD, VA (US); Marlyn Y. Andino, NEWPORT NEWS, VA (US)

(73) Assignee: U.S.A. AS REPRESENTED BY THE ADMINISTRATOR OF NASA

(21) Appl. No.: 15/941,569

(22) Filed: Mar. 30, 2018

Related U.S. Application Data
(60) Provisional application No. 62/479,561, filed on Mar. 31, 2017.

(51) Int. Cl. B64C 21/04; F16K 31/02

(52) U.S. Cl. CPC B64C 21/04; F16K 31/02

(57) ABSTRACT

Disclosed are fluidic actuator systems for active flow control applications, methods for making/using such fluidic actuator systems, and vehicles equipped with fluidic actuators to modify airfoil aerodynamics. A Spanwise Traveling Electro-Pneumatic (STEP) actuator architecture for active flow control (AFC) generates variable actuation using high-speed electronic valves to move an array of discrete jets in a spanwise direction. The STEP actuator uses pneumatic power to provide flow control authority and electric power to minimize system power requirements. Disclosed STEP actuator systems help to reduce mass flow requirements for equivalent flow control performance, e.g., when compared to steady blowing systems. This flow control approach may provide necessary flow control authority, for example, for high-lift systems, while keeping pneumatic power requirements (e.g., mass flow and pressure) for the AFC system within an aircraft's capability for system integration. Disclosed STEP actuators systems may regulate spanwise flow encountered by many aircrafts, including swept-back wing configurations.

### CROSS-REFERENCE TO RELATED PATENT APPLICATION

This patent application claims the benefit of and priority to U.S. Provisional Patent Application No. 62/479,561, filed on Mar. 31, 2017, the contents of which are hereby incorporated by reference in their entirety and for all purposes.

### STATEMENT REGARDING FEDERALLY SPONSORED RESEARCH OR DEVELOPMENT

The invention described herein was made by employees of the United States Government, and may be manufactured and used by or for the Government of the United States of America for governmental purposes without the payment of any royalties thereon or therefore.

### BACKGROUND

The present disclosure relates generally to features for improving the aerodynamic performance of vehicles. More specifically, aspects of this disclosure relate to fluidic actuator systems and methods for active flow control.

Many current production vehicles, such as the modern-day airplane, are originally equipped with or retrofit to include stock body hardware or aftermarket accessories that are engineered to improve the aerodynamic performance of the vehicle. In aeronautical applications, for example, various features and devices have been proposed for reducing the cruise drag associated with a high-lift system without sacrificing the aircraft's aerodynamic and acoustic performances. Most aircraft utilize an aerodynamically efficient cruise wing configuration for steady-state flight, such as cruising operations, and a modified high-lift wing configuration to modulate lift forces for transient-state flight, such as takeoff and landing operations.

Some conventional high-lift aircraft systems are designed to re-shape sections of the wing to increase airfoil camber and thereby increase lift for takeoff and landing. Due to adverse pressure gradients generated during such operations, high-lift systems may be vulnerable to flow separation that can result in loss of aerodynamic performance. An available technique for ameliorating this performance loss is to increase the wetted area of the high-lift system. In so doing, comparable aerodynamic performance is achieved with moderate camber, which helps to minimize or eliminate flow separation (e.g., at the vertical tail of a civilian transport aircraft). Increasing the wetted area of a high-lift system, however, may exacerbate drag and increase gross vehicle weight. Another technique to achieve desired high-lift performance is to implement slotted-flow features to modify the aerodynamic properties of the wing. However, slotted leading and trailing-edge devices, and the associated sub-systems necessary to change the wing configuration from cruise to low-speed conditions, are complex and employ a significant number of parts to enable safe operation. In addition, these complex high-lift systems often protrude externally under the wings—and require external fairings—resulting in increased cruise drag. An alternative approach is to use an active flow control (AFC) system to minimize associated external drag of the high-lift devices (e.g., Fowler flaps) and selectively provide desired high-lift performance, e.g., while reducing wing size (e.g., “wetted area”) and system part count.

A major drawback of some available AFC systems for high-lift applications is that they require more power than what is available from an aircraft during takeoff and landing operations, especially when the engines are in idling mode during landing. In terms of power usage, there are two main types of AFC systems: a first type uses electric-powered actuators, such as plasma actuators or synthetic jet actuators, to generate a meaningful flow-control effect on a wing control surface; a second type uses pneumatic-powered actuators, such as steady blowing actuators and fluidic oscillators, to generate a meaningful effect on the control surface. Although the power consumption of electrically powered actuators is practical, they tend to offer limited control authority. Pneumatic-powered actuators, on the other hand, offer sufficient control authority, but usually require more power—mass flow and pressure—than what is available, e.g., from engine bleed air. Generally speaking, there is a technology performance gap between existing AFC-power requirements and available aircraft power.

### SUMMARY

Disclosed herein are electronically controlled fluidic actuator systems and related control logic for active flow control of airfoils, methods for making and methods for using such fluidic actuator systems, and vehicles equipped with fluidic actuator systems operable to actively modify the aerodynamic characteristics of airfoils. By way of example, there is disclosed a novel Spanwise Traveling Electro-Pneumatic (STEP) actuator architecture for AFC applications, in which the STEP actuator generates a series of unsteady discrete fluid jets movable in the spanwise direction of the airfoil using an array of high-speed electronic valves. The ability to selectively provide unsteady actuation (discontinuous flow) has been shown to increase AFC system performance by reducing its pneumatic and electrical power requirements. For example, flow separation control with pulsed blowing, e.g., at discrete locations, has been shown to be more energy efficient than steady (continuous) blowing, e.g., across the entire expanse of the wing, thus requiring considerably less flow rate for a specific performance increment.

Attendant benefits for at least some of the disclosed STEP actuator architectures and control methodologies may include an estimated 500-750 lbs. reduction in operating empty weight (OEW), with a concomitant estimated cruise drag reduction of 3.3 counts over a counterpart civil transport aircraft. Other possible benefits may include an estimated fuel savings of about 300-400 gals/flight. Aspects of the disclosed concepts also help to improve aircraft operating range, climb rate, and cargo capacity, while also helping to reduce fuel consumption, operating noise and emission levels. Another advantage of disclosed STEP actuator architectures using high-speed electronic valves is the ability to provide on-demand, adaptive flow control with reduced fluid leakage over AFC systems that utilize self-rotating, slotted concentric cylinders as the flow control actuator.

Aspects of the present disclosure are directed to fluidic actuator systems for actively modifying airflow across an airfoil. The airfoil, which may be embodied as the wing of an aircraft—be it a main wing, a winglet, a stabilizer tail wing, etc.—has a wetted surface that contacts the ambient airflow. This airfoil also has opposing leading and trailing edges, a chordwise direction extending in a straight line from the leading to the trailing edge, and a spanwise direction transverse to the chordwise direction. A representative fluidic actuator system includes a fluid source, such as a pressurized plenum chamber for receiving and accumulating engine air bleed, and a plurality of nozzles receiving fluid from the fluid source, e.g., via assorted fluid conduits. Each nozzle is fabricated to attach at a discrete location of the airfoil, spaced from adjacent nozzles in the spanwise direction. The nozzles may be arranged in a single row or an array of rows and columns, as an example. These nozzles direct fluid outwardly from the wetted surface. The fluidic actuator system also includes a plurality of electronic fluid valves, such as high-speed solenoid valves, each of which fluidly connects a respective one or a plurality of the nozzles to the fluid source. These electronic valves are selectively actuable, singly and jointly, to discharge a single fluid jet from a single one of the nozzles at a given time and, when desired, to discharge multiple fluid jets from a combination of the nozzles at a given time.

Other aspects of the present disclosure are directed to methods of fabricating and methods of operating fluidic actuator systems for actively modifying airflow across an airfoil of a vehicle. A representative method of assembling a fluidic actuator system for an active aerodynamic fluid control application includes, in any order and in any combination with any of the disclosed features and options: mounting a fluid source to a vehicle; mounting a plurality of fluid nozzles to the vehicle such that each nozzle is attached at a discrete location of an airfoil, spaced from adjacent nozzles in the spanwise direction, each of the nozzles being configured to direct fluid outwardly from the wetted surface; and, mounting a plurality of electronic fluid valves to the vehicle, each of the electronic valves fluidly connecting a respective one or a plurality of the nozzles to the fluid source, the electronic valves being selectively actuable to discharge a single fluid jet from a single one of the nozzles and to discharge multiple fluid jets from a combination of the nozzles. The nozzles may be arranged in a single row, multiple rows, or in a variety of different geometric configurations.

Additional aspects of the present disclosure are directed to self-propelled vehicles equipped with fluidic actuator systems operable to actively modify the aerodynamic characteristics of airfoils. In an example, an aircraft is disclosed with an elongated aircraft body, and one or more airfoils attached to the aircraft body. Each airfoil has a wetted surface, opposing leading (fore) and trailing (aft) edges, opposing wing root and wing tip ends, a chordwise direction extending from the leading to the trailing edge, and a spanwise direction extending from the wing root to wing tip ends, transverse to the chordwise direction. An electronic vehicle controller is also attached to the aircraft body.

Continuing with the above example, the aircraft is also equipped with a fluidic actuator system that is operable to actively modify fore-aft airflow across the wetted surface of the airfoil(s). This fluidic actuator system includes a fluid source, which is operable for aggregating pressurized air, and a series of nozzles, each of which is mounted at a discrete location of the airfoil, spaced from adjacent nozzles in the spanwise direction. Each nozzle is configured to direct fluid outwardly from the wetted surface of an airfoil. The aircraft is also equipped with a series of electronic valves, each of which fluidly connects a respective one or a plurality of the nozzles to the fluid source. The electronic valves are individually and collectively actuable, responsive to a trigger signal received from the vehicle electronic controller, to selectively discharge a single fluid jet from a single one of the nozzles, and to selectively discharge multiple fluid jets from a combination of the nozzles, respectively.

The above summary does not represent every embodiment or every aspect of the present disclosure. Rather, the foregoing summary merely provides an exemplification of some of the novel concepts and features set forth herein. The above features and advantages, and other features and advantages of the present disclosure, will be readily apparent from the following detailed description of illustrative embodiments and representative modes for carrying out the present disclosure when taken in connection with the accompanying drawings and the appended claims. Moreover, this disclosure expressly includes any and all combinations and subcombinations of the elements and features presented above and below.

### BRIEF DESCRIPTION OF THE DRAWINGS

FIG. 1 is an elevated, plan-view illustration of a representative vehicle equipped with a fluidic actuator system for active fluid control (AFC) of an airfoil in accordance with aspects of the present disclosure.

FIG. 2 is a schematic illustration of the representative fluidic actuator system for AFC applications of FIG. 1.

FIGS. 3A-3D are schematic illustrations of different representative air-jet nozzles for use with the fluidic actuator system of FIG. 2 in accordance with aspects of the present disclosure.

FIGS. 4A-4E are schematic illustrations of a representative airfoil equipped with the fluidic actuator system of FIG. 2 showing optional fluid jet sequencing in accordance with aspects of the present disclosure.

The present disclosure is amenable to various modifications and alternative forms, and some representative embodiments have been shown by way of example in the drawings and will be described in detail herein. It should be understood, however, that the novel aspects of this disclosure are not limited to the particular forms illustrated in the appended drawings. Rather, the disclosure is to cover all modifications, equivalents, combinations, subcombinations, permutations, groupings, and alternatives falling within the scope of this disclosure as defined by the appended claims

### DETAILED DESCRIPTION

This disclosure is susceptible of embodiment in many different forms. There are shown in the drawings and will herein be described in detail representative embodiments of the disclosure with the understanding that these illustrated examples are provided as an exemplification of the disclosed principles, not limitations of the broad aspects of the disclosure. To that extent, elements and limitations that are described, for example, in the Abstract, Summary, and Detailed Description sections, but not explicitly set forth in the claims, should not be incorporated into the claims, singly or collectively, by implication, inference or otherwise.

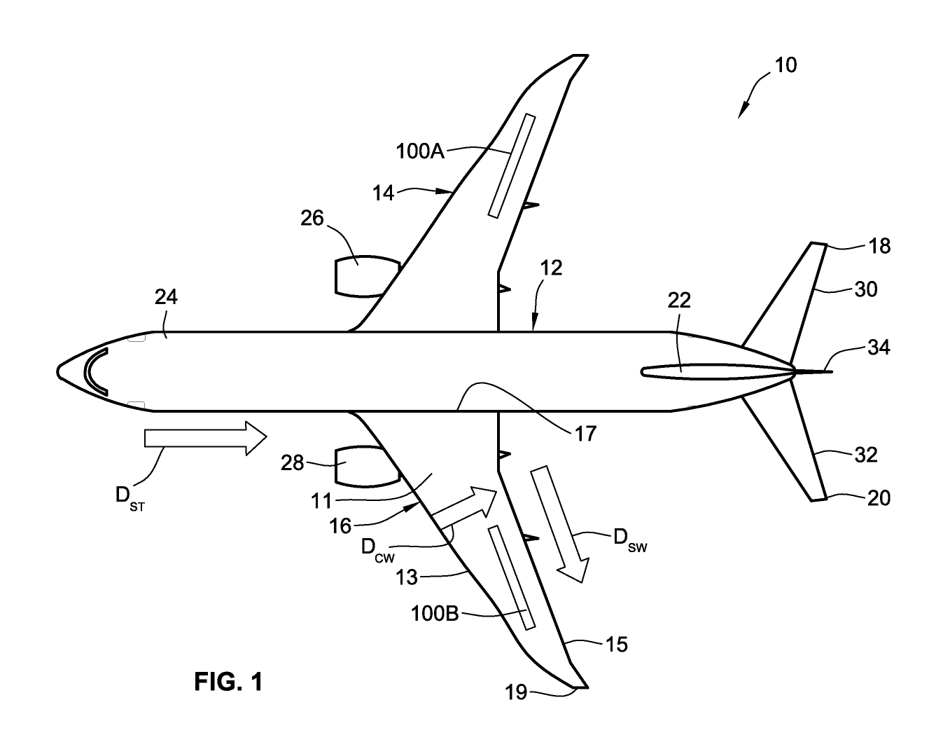

For purposes of description herein, the terms “upper,” “lower,” “right,” “left,” “rear,” “front,” “vertical,” “horizontal,” and derivatives thereof shall relate to the vehicle as oriented in FIG. 1. Moreover, words of approximation, such as “about,” “almost,” “substantially,” “approximately,” and the like, may be used herein in the sense of “at, near, or nearly at,” or “within 0-5% of,” or “within acceptable manufacturing tolerances,” or any logical combination thereof, for example. It is to be understood that the disclosed concepts may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Aspects of the disclosed concepts are directed to active flow control systems that help to improve aircraft operation, including improving aerodynamic lift and drag performance with reduced fuel burn, operating noise, runway path, etc. In at least some configurations, disclosed AFC actuators offer an effective control strategy through minimal energy expenditure to achieve desired flow control authority. There is disclosed a novel flow control approach that provides the necessary aerodynamic performance for a high-lift aircraft control system, while keeping pneumatic power requirements (mass flow and pressure) of the AFC actuators within an aircraft's capability for system integration. To reduce mass flow rate with a comparable lift coefficient, a disclosed STEP actuator architecture utilizes an array of high-speed electronic valves operated autonomously by an in-vehicle controller to generate synchronous and asynchronous spanwise moving jets of air. In this arrangement, the blowing jets of air may be selectively applied to discrete segments of the airfoil, thereby reducing mass flow rate proportional to the segment size of a single slot with a continuous fluid jet. By selectively moving segmented jets of air in the spanwise direction, an entire flap surface can be covered in a manner similar to steady blowing from an elongated slot spanning the extent of the airfoil.

Referring now to the drawings, wherein like reference numbers refer to like features throughout the several views, there is shown in FIG. 1 an illustration of a representative aircraft, which is designated generally at 10 and portrayed herein for purposes of discussion as a commercial airliner. Mounted to the body 12 of the aircraft 10, e.g., in a sweptback mid-mount wing configuration, are a number of different airfoils 14, 16, 18, 20 and 22. The illustrated aircraft 10—also referred to herein as “vehicle”—is merely an exemplary application with which novel aspects and features of this disclosure may be practiced. As such, it will be understood that aspects and features of this disclosure may be applied to other aircraft types, may be incorporated into various available wing configurations, and may be implemented for any logically relevant type of vehicle, including spacecraft, boats, motor vehicles, etc. Lastly, the drawings presented herein are not necessarily to scale and are provided purely for instructional purposes. Thus, the specific and relative dimensions shown in the drawings are not to be construed as limiting.

In the representative vehicle configuration of FIG. 1, the aircraft 10 includes an elongated main body section or “fuselage” 24 with its major longitudinal dimension extending in a streamwise direction D_{ST} of oncoming ambient airflow, and is generally designed to hold a flight crew, passengers, cargo, etc. The term “streamwise,” as used herein, may generally refer to a direction of ambient air flowing towards and across the external surfaces of the aircraft 10 when the aircraft 10 is in steady-state flight. Projecting transversely from the aircraft body 12, angled in a rearward direction from opposing sides of the fuselage 24, is a pair of wings 14 and 16. These wings 14, 16 may each be defined as a rigid, airfoil-shaped structure that produces an aerodynamic force, such as lift or drag or moment, during propulsion through a fluid. Each wing 14, 16 therefore has: (1) a wetted surface, designated generally at 11 in FIG. 1, which is in contact with external airflow, e.g., during flight; (2) a chordwise direction D_{CW} extending in a straight line from a leading 13 to a trailing edge 15 of the wing, shown obliquely angled with respect to the streamwise direction D_{ST}; and (3) a spanwise direction D_{SW} extending in a straight line from a wing root 17 to a wing tip 19, transverse to the chordwise direction D_{CW}. While any of an assortment of available engine types and layouts may be implemented, the aircraft 10 of FIG. 1 employs a wing-mounted, two-engine layout with a first turbofan engine 26 mounted beneath the first wing 14 and a second turbofan engine 28 mounted beneath the second wing 16. It is envisioned that the aircraft 10 take on other types of engine layouts with any number of engines, each of which may be similar to or different from the engine type illustrated herein.

Aircraft 10 of FIG. 1 is also equipped with three tail wings: a first horizontal stabilizer 18, a second horizontal stabilizer 20, and a vertical stabilizer 22, each of which is mounted to and projects outwardly from a tail end of the elongated fuselage 24. Although shown with a fuselage-mounted tailplane configuration having a single vertical tail wing, the aircraft 10 may take on other tailplane configurations, including those with more than one vertical stabilizer as well as tailless, V-tail, tandem, and canard arrangements. First and second horizontal stabilizers 18, 20 extend laterally from the elongated aircraft body 12, angled in a rearward direction from opposing sides of the fuselage 24. Vertical stabilizer 22, on the other hand, extends in an upward direction from the fuselage 24, oriented substantially perpendicular with respect to the horizontal stabilizers 18, 20. In the representative arrangement of FIG. 1, each of the tail-wing stabilizers 18, 20, 22 includes a respective control member 30, 32 and 34—illustrated in each instance as a tail rudder—that helps to control the aircraft's directional stability, including vehicle pitch and yaw, during flight.

To help optimize aerodynamic performance during transient and steady-state flight maneuvers, including improving lift and drag performance with increased fuel economy and reduced operating noise, aircraft 10 is retrofit or stock equipped with one or more fluidic actuator systems, designated generally at 100A and 100B in FIG. 1, for actively modifying airflow across the main wings 14, 16. In particular, the illustrated aircraft 10 is equipped with a first fluidic actuator system 100A for reducing flow separation and attendant drag along a select segment of the first wing 14, and a second fluidic actuator system 100B for reducing flow separation and attendant drag along a select segment of the second wing 16. It should be appreciated, however, that the aircraft 10 may be provided with greater or fewer than the two illustrated fluidic actuator systems. In the same vein, each such system may take on similar or different locations, sizes and orientations than that shown in the drawings to modify the aerodynamic performance of any of the airfoils 14, 16, 18, 20 and 22 of FIG. 1. For instance, a fluidic actuator system may be implemented for any high-lift component, set of components and/or control surfaces (e.g., slats, main elements, flaps, ailerons, rudders, etc.).

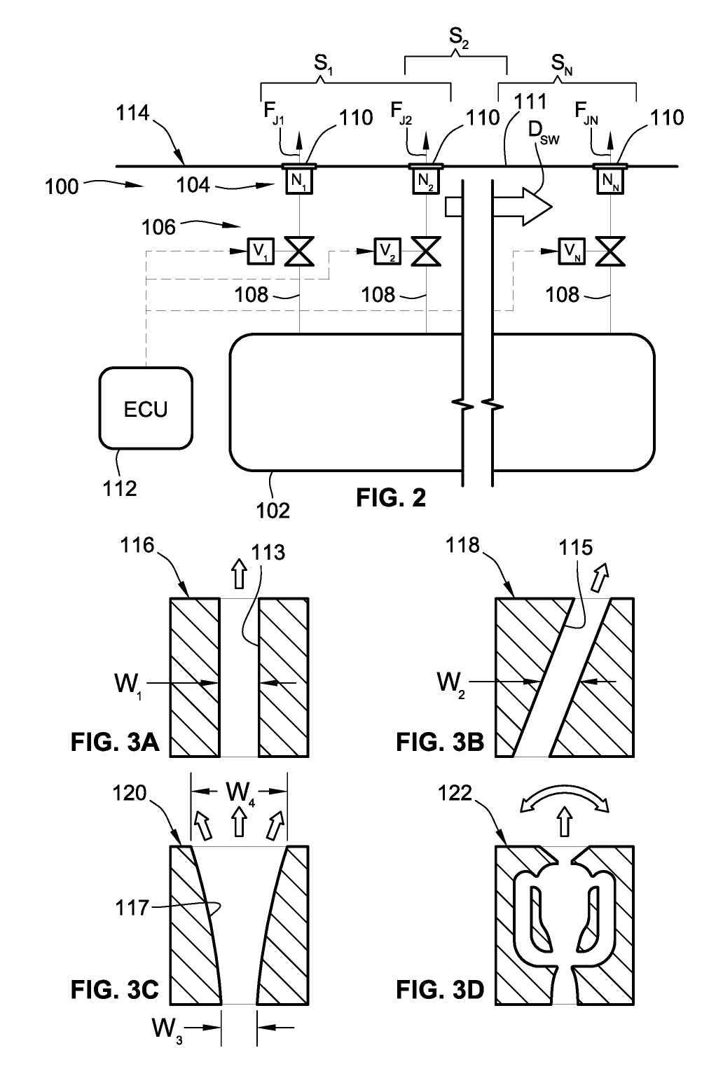

In accordance with the illustrated example, the first and second fluidic actuator systems 100A, 100B of FIG. 1 may be generally identical in construction and functionality; as such, for purposes of brevity and conciseness, both systems 100A and 100B are described below in accordance with the architecture 100 illustrated in FIG. 2. As will be described in extensive detail hereinbelow, the architecture 100 of FIG. 2 is embodied as a Spanwise Traveling Electro Pneumatic actuator for active flow control of an airfoil 114. The illustrated STEP actuator architecture 100 is generally composed of a fluid source 102, a series of nozzles 104, and an array of electronically actuated valves 106. As shown, there are multiple nozzles N₁, N₂ . . . N_{N} operated—individually and jointly—by a corresponding number of valves V₁, V₂ . . . V_{N}, all of which are fluidly connected to the fluid source 102 via wear-resistant, fluid-tight hoses 108 or other suitable fluid conduits. Fluid source 102 is portrayed as a pneumatic plenum chamber that receives and accumulates pressurized air, e.g., that is bled from the aircraft's engines 26, 28. Optional alternative arrangements may supplement or substitute the plenum 102 with an auxiliary power unit, an air compressor, a collection of compact compressors, or other suitable device or set of devices.

Each of the nozzles N₁, N₂ . . . N_{N} in the nozzle series 104 is designed to attach at a discrete location of the airfoil 114, e.g., mounted to an underside surface thereof via a respective mounting bracket and grommet 110. Once properly mounted, the series of nozzles 104 is dispersed over the length of the airfoil 114 such that each nozzle is spaced from its neighboring nozzle/nozzles N₁, N₂ . . . N_{N} in the spanwise direction (left-to-right in FIG. 2). These nozzles N₁, N₂ . . . N_{N} direct individual jets of fluid F_{J1}, F_{J2} . . . F_{JN} outwardly from the wetted surface 111 of the airfoil 114 for flow separation control. It is envisioned that the individual nozzles take on an assortment of nozzle configurations to emit any desired spray pattern. By way of non-limiting example, one, some or all of the nozzles may take on a straight nozzle 116 configuration (FIG. 3A), an angled nozzle 118 configuration (FIG. 3B), a diffuser nozzle 120 configuration (FIG. 3C), and/or an oscillating nozzle 122 configuration (FIG. 3D). The straight nozzle 116 is fabricated with an internal fluid channel 113, which has a substantially constant width W₁ and is substantially orthogonal to the wetted surface 111 of the airfoil 114. By way of comparison, the angled nozzle 118 is fabricated with an internal fluid channel 115 that also has a substantially constant width W2, but is obliquely angled with respect to the airfoil's wetted surface 111. Diffuser nozzle 116, on the other hand, is fabricated with an internal fluid channel 117 that has a variable width, namely an inlet opening of a first width W3 and an outlet opening of a second width W4 that is greater than the first width W3. The oscillating nozzle 122 has a multi-channel, multi-width construction that is configured to function as a passive fluidic oscillator that generates an undulating fluid jet.

The array of electronically actuated valves 106 is portrayed in FIG. 2 as an ordered series of fluid control valves V₁, V₂ . . . V_{N} that individually fluidly connect respective ones of the nozzles N₁, N₂ . . . N_{N} to the fluid source 102. In accordance with aspects of the disclosed concepts, these electronic valves 106 may be embodied as high-speed solenoid valves, each of which is actuable in response to a trigger signal received from an in-vehicle or remote electronic controller 112. Depending on application-specific packaging, cost and performance constraints, for example, each valve V₁, V₂ . . . V_{N} may be a normally closed solenoid valve, e.g., with an approximately 0.2-1.6 millisecond response time, to eliminate leakage and to reduce power consumption. Optional architectures may employ other functionally equivalent high-speed electronic valve designs, including piezoelectric (“piezo”) valves, pneumatic flow control valves, motorized check and ball valves, etc. These electronic valves V₁, V₂ . . . V_{N} are selectively actuable, be it piecemeal, in designated subgroups, or all together as a cluster, to discharge a single fluid jet from a single one of the nozzles N₁, N₂ . . . N_{N} and to discharge multiple fluid jets from a combination of the nozzles N₁, N₂ . . . N_{N}. In FIG. 2, the dashed arrows interconnecting the various illustrated components are emblematic of electronic signals or other communication exchanges by which data and/or control commands are transmitted, wired or wirelessly, from one component to the other.

Electronic controller 112 of FIG. 2, which may be embodied as an onboard electronic control unit (ECU), is communicatively connected to the array of electronically actuated valves 106, and is programmed to execute memory-stored control logic to generate and transmit on-demand electronic trigger signals to the individual valves V₁, V₂ . . . V_{N}. By way of example, and not limitation, the electronic controller 112 is programmed to generate a trigger signal at every time t per wave cycle, where:

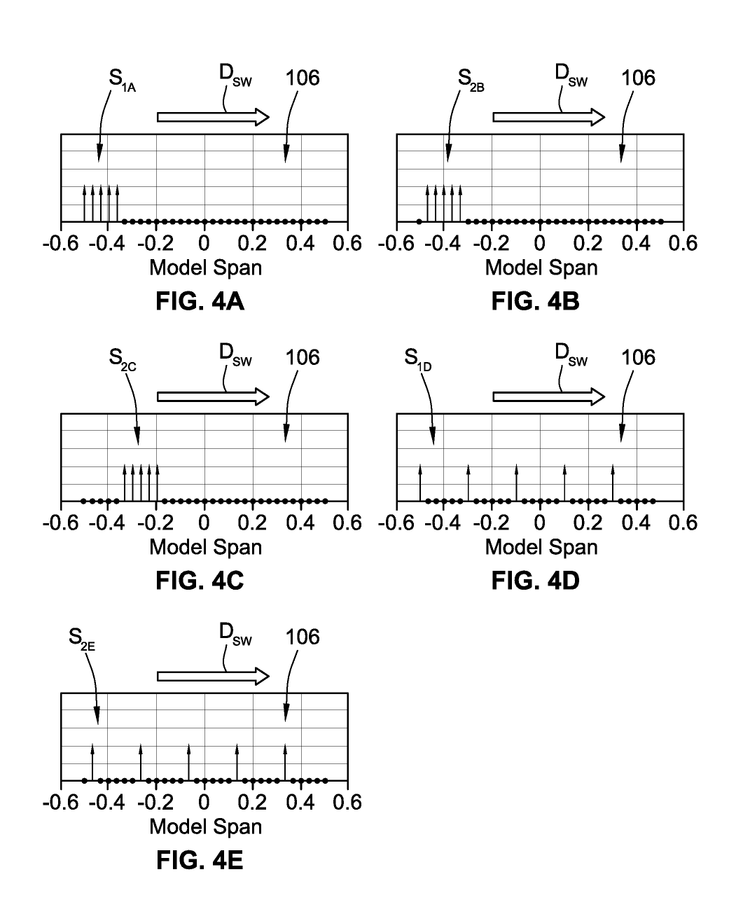

t=t₀+1/f

wherein t₀ is a first activation time, e.g., upon initialization of each wave cycle, and f is a valve operating frequency. As will be detailed below in the discussion of FIGS. 4A-4E, electronic controller 112 may be programmed to complete a single wave cycle or a calibrated number of wave cycles for a designated number N of the electronic valves V₁, V₂ . . . V_{N}, e.g., where N comprises a subgroup of the available valves or all of the valves in the array 106. A single wave cycle may include transmitting a trigger signal to: only a first valve V₁ of the electronic valves at t=t₀; only a second valve V₂ of the electronic valves at t=t₁; only an Nth valve V_{N} of the electronic valves at t=t_{N}; and so on until all of the valves V₁, V₂ . . . V_{N} in the designated number N have been activated. To generate a series of discrete fluid jets traveling in the spanwise direction D_{SW} of the airfoil 114, the array of electronic valves 106 may be activated one at a time in sequence, e.g., from the wing root to the wing tip in the spanwise direction D_{SW}, or vice versa. As another option, the electronic controller 112 may be programmed to complete a wave cycle for a designated number N of subsets of the electronic valves V₁, V₂ . . . V_{N}. In this instance, a single wave cycle may include transmitting a trigger signal to: only a first subset S₁ of multiple valves V₁, V₂ . . . V_{N} at t=t₀; only a second subset S₁ of multiple valves V₁, V₂ . . . V_{N} at t=t₁; only an Nth subset S_{N} of multiple electronic valves V₁, V₂ . . . V_{N} at t=t_{N}; and so on until all of the valve subsets in the designated number N have been activated. As shown, each subset S₁, S₂ . . . S_{N} includes two or more of the electronic valves V₁, V₂ . . . V_{N}. To generate a series of discrete fluid jets traveling in the spanwise direction D_{SW} of the airfoil 114, the array of electronic valves 106 may be activated one subset S₁, S₂ . . . S_{N} at a time in sequence, e.g., from wing tip to wing root in the spanwise direction D_{SW}, or vice versa.

As indicated above, electronic controller 112 is constructed and programmed to govern, among other things, the operation of the STEP actuator architecture 100 to selectively modify the aerodynamic characteristics of the airfoil 114. Control module, module, controller, control unit, electronic control unit, processor, and any permutations thereof may be defined to mean any one or various combinations of one or more of logic circuits, Application Specific Integrated Circuit(s) (ASIC), electronic circuit(s), central processing unit(s) (e.g., microprocessor(s)), and associated memory and storage (e.g., read only, programmable read only, random access, hard drive, tangible, etc.), whether resident, remote or a combination of both, executing one or more software or firmware programs or routines, combinational logic circuit(s), input/output circuit(s) and devices, appropriate signal conditioning and buffer circuitry, and other components to provide the described functionality. Software, firmware, programs, instructions, routines, code, algorithms and similar terms may be defined to mean any controller executable instruction sets including calibrations and look-up tables. The ECU may be designed with a set of control routines executed to provide the desired functions. Control routines are executed, such as by a central processing unit, and are operable to monitor inputs from sensing devices and other networked control modules, and execute control and diagnostic routines to control operation of devices and actuators. Routines may be executed in real-time, continuously, systematically, sporadically and/or at regular intervals, for example, each 100 microseconds, 3.125, 6.25, 12.5, 25 and 100 milliseconds, etc., during ongoing vehicle use or operation. Alternatively, routines may be executed in response to occurrence of an event.

In accord with aspects of the disclosed concepts, generating spanwise traveling jets by the STEP actuator architecture 100 of FIG. 2 may be obtained by operating the valve array 106 in any of an assortment of particular control schemes, some examples of which are provided in FIGS. 4A-4E of the drawings. In FIGS. 4A, 4B and 4C, for instance, subsets of only five actuators, designated S_{1A}, S_{2B} and S_{2C}, respectively, are activated (turned on) at any point in time. With the system architecture 100 of FIG. 2, however, any number of nozzles N₁, N₂ . . . N_{N} can be made operational at any point in time since the electronic valves V₁, V₂ . . . V_{N} may be controlled separately and jointly via the electronic controller 112. Consequently, mass flow may be limited to only the active nozzles so that overall system mass flow requirements are reduced when compared to steady blowing system configurations that continuously emit fluid jets through all fluid outlets. For FIGS. 4A-4E, circles denote inactive (turned off) valves and arrows indicate active (turned on) valves. It should be appreciated that the control schemes illustrated in FIGS. 4A-4E are purely representative and, thus, non-limiting. As such, any of these concepts may be modified or combined with any of the other features and configurations described above and below.

FIG. 4A may be representative of the initialization of a wave cycle, at t=t₀, where a first subset S_{1A} of five adjacent valves V₁, V₂ . . . V_{N} is simultaneously activated via the electronic controller 112. At t=t₁, which may be represented by FIG. 4B, a second subset S_{2B} of five adjacent valves V₁, V₂ . . . V_{N}, distinct from the first subset S_{1A}, is simultaneously activated. For instance, a first (leftmost) valve in the array 106 of FIG. 4B, which was originally active in FIG. 4A, is shown deactivated while a sixth valve (counting from left-to-right), which was originally inactive in FIG. 4A, is shown activated. Activation and deactivation of electronic valves or valve subsets may be performed in any desired manner, whether it be simultaneously, sequentially, with a calibrated delay, asynchronously, etc. This process may be repeated to continuously generate groupings of five fluid jets that essentially move in the spanwise direction D_{SW} (left-to-right in FIGS. 4A-4E) for a select segment, select segments, the entire length of, or the entirety of the airfoil 114 with a calibrated frequency. This jet traveling frequency may depend, for example, on the valve operating frequency f the number of valves open at a given time, and a total number of valves. This configuration may be designated as a “single-wave” actuator control scheme when only one wave is generated and travels the entire width of the airfoil/system.

Another variant of the single-wave actuator control scheme may be achieved by grouping the valves into subsets, as described above, and activating/deactivating multiple valves at a given time, as can be seen with collective reference to FIGS. 4A and 4C, as opposed to activating a single valve and deactivating a single valve at a given time, as previously described with respect to FIGS. 4A and 4B. For instance, at t=t₁ in FIG. 4C, another second subset S_{2C} of five adjacent valves V₁, V₂ . . . V_{N}, distinct from the first subset S_{1A} of FIG. 4A, is simultaneously activated by deactivating the first five valves in the array 106 and substantially contemporaneously activating a second five valves. While the first variant generates a continuous (or smoother) jet movement, the second variant generates discontinuous jet movement with faster jet travelling speed. Alternatively, FIG. 4C may be representative of the first variant discussed above, e.g., at t=t₆, in which the first five valves were deactivated, one at a time from t₁ through t₆, while the second five valves were sequentially activated, one at a time from t₁ through t₆. A sub variant of this configuration may be achieved by connecting, for example, a first subset of (five) adjacent nozzles to a first valve V₁, a second subset of (five) adjacent nozzles to a second valve V₂, . . . so on, and operating the first valve (V₁) at t=t₀ and the second valve (V₂) at t=t₁ . . . and so on. This configuration is operable to generate the same single-wave of fluid jet pulses, but reduces the number of valves depending on the group size (e.g., five in this example).

FIG. 4D may be representative of the initialization of a wave cycle, at t=t₀, where a first subset S_{1D} of non-adjacent valves V₁, V₂ . . . V_{N} is simultaneously activated via the electronic controller 112. At t=t₁, which may be represented by FIG. 4E, a second subset S_{2E} of non-adjacent valves V₁, V₂ . . . V_{N}, distinct from the first subset S_{1D}, is simultaneously activated. For both FIGS. 4D and 4C, it can be seen that each active valve (arrow) of an activated subset S_{1D}, S_{2E} is spaced from the next active valve (arrow) in the sequential array 106 by multiple inactive vales (circles). In particular, the first subset S_{1D} includes the 1^{st}, 7^{th} 13^{th}, 19^{th} and 25^{th} valves activated at to; comparatively, the first subset S_{1D} is deactivated at t₁ and the second subset S_{2E}, comprising the 2^{nd}, 8^{th}, 14^{th}, 20^{th} and 26^{th} valves, is concomitantly activated. This process may be repeated to continuously generate groupings of non-adjacent fluid jets that essentially move in the spanwise direction D_{SW} for a select segment or segments of the entire length of the airfoil 114 with a calibrated frequency. This second configuration may be designated as a “multi-wave” actuator control scheme where, starting from the first (leftmost) valve, every-sixth-other actuators are turned on at t=t₀ (FIG. 4D). At t=t₁, all of these actuators are turned off and the next group of every-sixth-other actuators are turned (FIG. 4E) on. When the process is repeated, the fluidic actuator system 100 may generate spanwise traveling jets with the same traveling frequency.

A sub variant of this configuration may be achieved by connecting, for example, a first subset of multiple non-adjacent nozzles to a first valve V₁, a second subset of multiple non-adjacent nozzles to a second valve V₂, . . . so on, and operating the first valve (V₁) at t=t₀, the second valve (V₂) at t=t₁ . . . and so on. This embodiment still generates the same multi-wave actuator but reduces the number of valves depending on the group size (e.g., five in this example). Both the single-wave and multi-wave control schemes may be used to generate spanwise traveling jets that help to reduce the pneumatic (mass flow and pressure) requirements and electrical consumption of the STEP actuator architecture 100 as compared to many conventional AFC actuator systems, while improving the aerodynamic performance of a high-lift system.

A major advantage of the illustrated design is the elimination of flow leakage at the deactivated (turned off) segments as compared to concentric-cylinder actuator designs. Using two concentric cylinders where an inner cylinder rotates freely inside an outer, stationary cylinder requires there be at least some gap between the cylinders. Since the fluid jet out of an AFC device is typically high pressure, even a small gap results in a substantial leak from the passive segments. In addition to adversely affecting the system's flow control, a leak also increases operational mass flow requirements. Another attendant benefit of the illustrated design is the option to activate the electronic valves in any desired actuation combination in any desired sequence. For example, if desired, steady blowing can be achieved by continuously activating all or any particular valves without system modification. Moreover, pulsed blowing is also possible by turning valves on and off. Therefore, the current design is more adaptive to changing flow environments and different flight envelopes. On-demand actuation also enables the illustrated system to be used as a fluidic fence as needed. Boundary layer fences may be used to manipulate spanwise flow for aircraft stability control during low-speed maneuvers and landing, e.g., by changing the load distribution on swept wings[Office1]. Spaced jets can provide a jet curtain that reduces spanwise flow locally along the wing and can therefore be used as a boundary layer fence (i.e., fluidic fence). As another attendant benefit, the illustrated spanwise travelling electro pneumatic actuator architecture generates a net lateral flow in either the root-to-tip spanwise direction D_{SW} or reverse D_{SW} direction, e.g., depending on the actuation direction (i.e., actuation from wing root to wing tip or from wing tip to wing root). This net lateral flow may be used against the naturally occurring spanwise flow over the wing to enhance the aerodynamic efficiency again by changing the spanwise load distribution on swept wings.

### Test Data

To verify some of the STEP actuator concepts described above, a series of exploratory wind tunnel tests was performed on a wall-mounted hump model, which is the upper side of the Glauert airfoil. In the test model, the STEP actuator array consisted of 31 nozzles (0.04×0.22 inch) that spanned the entire width of the model. The nozzle exits were placed at the 65% of the airfoil model chord (e.g., at x/c=0.65 on a model scaled to length between x/c=0 and x/c=1), with a spacing between nozzles of about 0.65 inches. Each nozzle was fluidly connected to an individual high-speed electronic solenoid valve; all of the solenoid valves, in turn, were fluidly connected to a common plenum. Each solenoid valve was individually controlled by a trigger signal providing on-demand actuation.

The surface pressure (Cp) distributions along the model centerline were mapped for a freestream Mach number of 0.1. The baseline case, without active flow control, was shown to have a suction peak near x/c=0.56, followed by a decrease in suction pressure due to an adverse pressure gradient, and finally flow separation near x/c=0.67. Downstream of the model trailing edge (x/c=1), the centerline pressure continues to increase as the separated flow reattaches to the wall. Surface oil flow visualization indicated that the separated flow reattaches to the model surface at x/c=1.15.

Pressure distributions for flow control cases with steady blowing and with the STEP actuator architecture were also mapped. The steady blowing case study was generated by running all of the solenoid valves fully opened and the STEP actuator was operated with the multi-wave actuator control scheme (five jets). At the same momentum coefficient (Cμ) of 0.24%, both flow control techniques provided similar performance. Compared to the baseline case, they both increase suction pressure (i.e., reduced drag) upstream of the actuator location (x/c=0.65), and provide substantial pressure recovery downstream of baseline separation. Surface oil flow visualization of the flow control case with multi-wave STEP actuator control scheme indicated flow reattachment at x/c=0.86, resulting in substantially reduced flow separation compared to the baseline case where the reattachment was at x/c=1.15.

In the test study, the STEP actuator architecture and control scheme provided similar pressure distribution to the steady blowing case. This is because the momentum coefficient, which is commonly used as a scaling parameter, is the same for both flow control cases. However, the superiority of the STEP actuator architecture may be due to the reduction in the flow rate requirement for a similar performance, for example. For this particular momentum coefficient, steady blowing required a volume flow rate (Q) of 16.5 SCFM, (mass flow coefficient (C_{Q}) of 0.093%) of air flow and unsteady blowing using the STEP actuator (Multi Wave) required only Q of 6.64 SCFM (C_{Q}=0.037%) of air flow, which is a 60% reduction in the mass flow rate compared to the steady blowing.

Spanwise Cp distributions near the trailing edge (x/c=0.89) of the model were also mapped. It was shown that the baseline spanwise Cp distribution at a trailing edge shows fairly 2D flow separation. Application of STEP actuator architecture helps to increase pressure recovery, but may generate a slight asymmetry in the spanwise Cp distribution, where the actuator provides more pressure recovery opposite to the jet traveling direction. As is consistent with the spanwise Cp distribution, surface oil flow visualization showed a net lateral flow opposite to the jet traveling direction. The lateral flow may be strong enough to deflect the high speed jets out of the actuators.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A fluidic actuator system for actively modifying airflow across an airfoil, the airfoil having a wetted surface, opposing leading and trailing edges, a chordwise direction extending from the leading to the trailing edge, and a spanwise direction transverse to the chordwise direction, the fluidic actuator system comprising:
a fluid source;
a plurality of nozzles each configured to attach at a discrete location of the airfoil spaced from adjacent ones of the nozzles in the spanwise direction, and to direct fluid outwardly from the wetted surface; and
a plurality of electronic valves each fluidly connecting a respective one or a plurality of the nozzles to the fluid source, the electronic valves being selectively actuable to discharge a single fluid jet from a single one of the nozzles and to discharge multiple fluid jets from a combination of the nozzles.

2. The fluidic actuator system of claim 1, further comprising an electronic controller communicatively connected to the electronic valves, each of the electronic valves being actuable in response to a trigger signal received from the electronic controller.

3. The fluidic actuator system of claim 2, wherein the electronic controller is programmed to generate the trigger signal at every time t per wave cycle, where:
t=t₀+1/f
and wherein t₀ is a first activation time and f is a valve operating frequency.

4. The fluidic actuator system of claim 3, wherein the electronic controller is programmed to complete the wave cycle for a number N of the electronic valves, the wave cycle including transmitting the trigger signal to: only a first valve V₁ of the electronic valves at t=t₀; only a second valve V₂ of the electronic valves at t=t₁; only an Nth valve V_{N} of the electronic valves at t=t_{N}.

5. The fluidic actuator system of claim 4, wherein the airfoil includes laterally opposing tip and root ends, and wherein the electronic valves are activated sequentially in the spanwise direction between the tip and root ends.

6. The fluidic actuator system of claim 3, wherein the electronic controller is programmed to complete the wave cycle for a number N of subsets of the electronic valves, the wave cycle including transmitting the trigger signal to: only a first subset S₁ of multiple ones of the electronic valves at t=t₀; only a second subset S₂ of multiple ones of the electronic valves at t=t₁; only an Nth subset S_{N} of multiple ones of the electronic valves at t=t_{N}.

7. The fluidic actuator system of claim 6, wherein each of the subsets includes two or more of the electronic valves.

8. The fluidic actuator system of claim 7, wherein the airfoil includes laterally opposing tip and root ends, and wherein the subsets of electronic valves are activated sequentially in the spanwise direction between the tip and root ends.

9. The fluidic actuator system of claim 1, wherein the airfoil is mounted to a vehicle with an electronic vehicle controller, and wherein the plurality of electronic valves includes multiple high-speed solenoid valves each actuable in response to a trigger signal received from the electronic vehicle controller.

10. The fluidic actuator system of claim 1, wherein the airfoil is mounted to a vehicle with an engine, and wherein the fluid source includes a plenum, configured to accumulate bleed air received from the engine of the vehicle, and/or other suitable compressed air source selected from the group consisting of an air compressor and a collection of compact compressors.

11. The fluidic actuator system of claim 1, wherein each of the nozzles includes a straight nozzle with an internal fluid channel having a substantially constant width, the internal fluid channel being substantially orthogonal to the wetted surface of the airfoil.

12. The fluidic actuator system of claim 1, wherein each of the nozzles includes an angled nozzle with an internal fluid channel having a substantially constant width, the internal fluid channel being obliquely angled with respect to the wetted surface of the airfoil.

13. The fluidic actuator system of claim 1, wherein each of the nozzles includes a diffuser nozzle with an internal fluid channel having an inlet opening of a first width and an outlet opening of a second width greater than the first width.

14. The fluidic actuator system of claim 1, wherein each of the nozzles includes a passive fluidic oscillator nozzle.

15. A method of assembling a fluidic actuator system for actively modifying airflow across an airfoil of a vehicle, the airfoil having a wetted surface, opposing leading and trailing edges, a chordwise direction extending from the leading to the trailing edge, and a spanwise direction transverse to the chordwise direction, the method comprising:
mounting a fluid source to the vehicle;
mounting a plurality of nozzles to the vehicle such that each of the nozzles is attached at a discrete location of the airfoil spaced from adjacent ones of the nozzles in the spanwise direction, each of the nozzles being configured to direct fluid outwardly from the wetted surface; and
mounting a plurality of electronic valves to the vehicle, each of the electronic valves fluidly connecting a respective one or a plurality of the nozzles to the fluid source, the electronic valves being selectively actuable to discharge a single fluid jet from a single one of the nozzles and to discharge multiple fluid jets from a combination of the nozzles.

16. An aircraft comprising:
an elongated aircraft body;
an airfoil attached to the aircraft body, the airfoil having a wetted surface, opposing leading and trailing edges, a chordwise direction extending from the leading to the trailing edge, and a spanwise direction transverse to the chordwise direction;
an electronic vehicle controller attached to the aircraft body; and
a fluidic actuator system operable to actively modify ambient airflow across the airfoil, the fluidic actuator system comprising:
a fluid source;
a plurality of nozzles each mounted at a discrete location of the airfoil spaced from adjacent ones of the nozzles in the spanwise direction, each of the nozzles being configured to direct fluid outwardly from the wetted surface; and
a plurality of electronic valves each fluidly connecting a respective one or a plurality of the nozzles to the fluid source, the electronic valves being individually and collectively actuable, responsive to a trigger signal received from the vehicle electronic controller, to selectively discharge a single fluid jet from a single one of the nozzles and to selectively discharge multiple fluid jets from a combination of the nozzles, respectively.

17. The aircraft of claim 16, wherein the electronic vehicle controller is programmed to generate the trigger signal at every time t per wave cycle, where:
t=t₀+1/f
and wherein t₀ is a first activation time and f is a valve operating frequency.

18. The aircraft of claim 17, wherein the electronic vehicle controller is programmed to complete the wave cycle for a number N of the electronic valves, the wave cycle including transmitting the trigger signal to: only a first valve V₁ of the electronic valves at t=t₀; only a second valve V₂ of the electronic valves at t=t₁; only an Nth valve V_{N} of the electronic valves at t=t_{N}.

19. The aircraft of claim 18, wherein the airfoil includes laterally opposing tip and root ends, and wherein the electronic valves are activated sequentially in the spanwise direction between the tip and root ends.

20. The aircraft of claim 17, wherein the electronic controller is programmed to complete the wave cycle for a number N of subsets of the electronic valves, the wave cycle including transmitting the trigger signal to: only a first subset S₁ of multiple ones of the electronic valves at t=t₀; only a second subset S₂ of multiple ones of the electronic valves at t=t₁; only an Nth subset S_{N} of multiple ones of the electronic valves at t=t_{N}.
